(19) United States
(12) Patent Application Publication
(10) Pub. No.: US 2013/0045646 A1
(43) Pub. Date: Feb. 21, 2013

(54) BEARING APPARATUS FOR A POLE TERMINAL

(71) Applicant: Wolfgang B. Thoerner, Essen (DE)

(72) Inventor: Wolfgang B. Thoerner, Essen (DE)

(21) Appl. No.: 13/580,320

(22) PCT Filed: Feb. 9, 2011
(86) PCT No.: PCT/EP11/00607

§ 371 Date: Oct. 26, 2012

(30) Foreign Application Priority Data
Feb. 22, 2010 (DE) 20 2010 002 633.4

(51) Int. Cl. H01R 13/02

(52) U.S. Cl. 439/884

(57) ABSTRACT

The invention relates to a bearing apparatus for a pole terminal (b 2, 3) in a housing wall (6) of an electrical or electronic device, wherein the bearing apparatus (1) is comprised of a pole terminal receptacle for accommodating a pole terminal (2, 3). The invention proposes that the bearing apparatus (1) be comprised of a structure-borne noise-damping material, wherein the pole receptacle can be supported on the housing wall (6) by means of the structure-borne noise-damping material in the mounted state.

The invention relates to a bearing apparatus for a pole terminal in a housing wall of an electrical or electronic device, with the bearing apparatus having a pole terminal receptacle for accommodating the pole terminal.

Pole terminals are utilized to a large extent in consumer electronics, for example to couple loudspeakers via cable lines to amplifiers. Pole terminals are distinguished by the fact that they allow for easy manual coupling and uncoupling. Conventional pole terminals are usually screwed directly to a housing wall of a relevant electronic device of consumer electronics. Such a pole terminal is disclosed in DE 102 17 082 A1, for example. In general, a pole terminal is eventually understood to represent an electromechanical device for establishing a (single-pole or multi-pole) disconnectible electrical connection between a cable line and a device.

If two electrical conductors are mechanically connected via a pole terminal, an electrical resistance occurs at the transition between both conductors. This resistance depends on several factors, including but not limited to mechanical pressure by which the conductors are pressed together.

If the contact spot vibrates or oscillates, this pressure may nonticeably vary punctually in the rhythm of the oscillation. It means the signal in this rhythm is transmitted better or worse. This effect occurs above all with loudspeakers and is clearly audible as a distortion of the signal.

A direct arrangement of pole terminals at a housing wall of an electronic device has the disadvantage in that the structure-borne noise from this device is directly transferred to the pole terminal. With electrical devices in form of loudspeakers, in particular, this consequently leads to permanent mechanical oscillations of the pole terminal whereby the magnitude and number of the conducting contact points of the contact surface of the pole terminal are modulated with the relevant cable fastened to it directly or via a plug (e.g. a banana plug).

Microscopically viewed, an increase in the contact pressure between the contact surface of the pole terminal and the cable fastened to it maximally brings an increase in the number of conducting contact points, but no improvement in contact stability.

The modulation process resulting on account of the mechanical structure-borne noise burden of the electrical contact is non-linear in broad-band, i.e. distortions caused by structure-borne noise are irreparable.

Hence, it is the object of the present invention to optimize the transition resistance between the contact surface of a pole terminal an a relevant conductor element fastened to it.

The underlying task of the invention is solved by the features of the independent patent claims. Preferable embodiments are indicated in the dependent patent claims.

According to the present invention, a bearing apparatus for a pole terminal is created in a housing wall of an electronic device, this bearing apparatus having a pole terminal receptacle for accommodating the pole terminal, and with the bearing apparatus having a structure-borne noise-damping material, and with the pole terminal receptacle being supported on the housing wall via the structure-borne noise-damping material.

Embodiments of the present invention have an advantage in that the mechanical structure-borne noise burden of the pole terminal at the electronic device is minimized. By supporting the pole terminal via the structure-borne noise-damping material, structure-borne noise occurring is largely absorbed. Consequently, the pole terminal is accommodated mainly vibration-free in the pole terminal receptacle. Mechanical oscillations of the housing wall are therefore not transferred to the relevant pole terminals, so that a modulated mechanical structure-borne noise burden of the pole terminal contact is minimized with an appropriate electrical conductor or an appropriate plug connector.

It should be noted that the state considered “mounted state” is a state in which the bearing apparatus is fastened in the housing wall of the electronic device for the functional use.

In accordance with an embodiment of the present invention, the pole terminal receptacle is configured as a mainly rigid plate. For example, the plate may be manufactured from plastic in an injection moulding process. The plate is provided with a recess for the pole terminal so that a pole terminal of an actually conventional construction form may be utilized therein.

The structure-borne noise-damping material may be an elastomer material that forms a frame surrounding the rigid plate at least partly at the rim side. For example, the frame may be injection moulded at the rigid plate of the pole terminal receptacle. Via this frame the pole terminal receptacle can then be supported at the housing wall.

As has been outlined hereinabove, the elastic frame provides for reducing the transfer of structure-borne noise from the casing to the pole terminal, with the mounting of the pole terminal being executed in a conventional manner at the rigid plate.

Preferably the elastic frame may have a circumferential groove via which the pole terminal receptacle is immobilized in a positive-locking manner at the housing wall. On account of the frame's elasticity, the inventive bearing apparatus can just be clipped into a relevant recess of the housing wall to mount it at the housing wall.

In accordance with another embodiment of the present invention, the bearing apparatus is configured in multiple parts, and in its mounted state it overlaps the rim of a recess provided in the housing wall at the front and rear side of the housing wall. For example, the bearing apparatus may be configured as a bipartite apparatus, thereof one part being inserted into the recess specifically provided for this purpose in the housing wall from the rear side and the other part being inserted therein from the front side of the housing wall. Then these two parts are immobilized against each other, with both parts simultaneously overlapping the rim of the recess from the front and rear side of the housing wall and accommodating it between them (in a form-locking and/or force-locking manner). Thereby, the fixing at the housing wall is established in a particularly simple manner without additional fasteners.

On account of the inventive structure-borne noise-damping, the magnitude and number of the conducting contact points of the relevant contact surface between the pole terminal and the connectible line remains mainly constant, whereby the contact resistance between the pole terminal and the electrical conductor does not change. Modulation induced by structure-borne noise of electrical signals to be transmitted, for example HiFi-signals, is thus reliably prevented. Thus the sound quality of relevant HiFi components on the whole is increased.

Practical examples of the present invention are elucidated in greater detail in the following based upon relevant drawings, wherein:

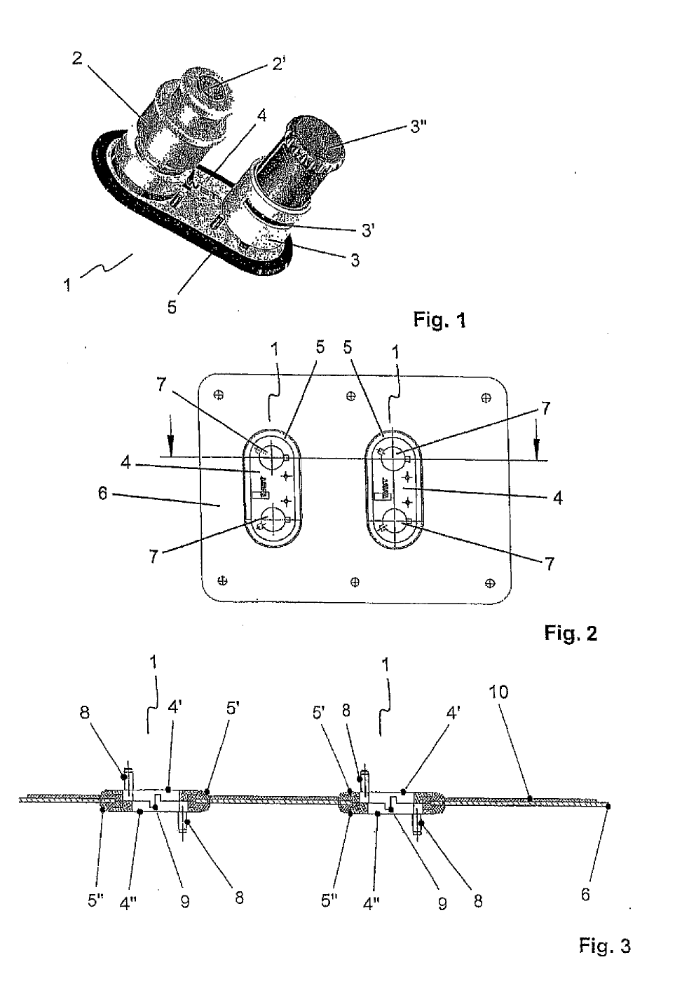

FIG. 1 shows a three-dimensional view of an inventive bearing apparatus with two pole terminals;

FIG. 2 shows a plan view on a mounting plate with two inventive bearing apparatuses;

FIG. 3 shows a sectional side view of the mounting plate according to FIG. 2.

In FIG. 1, the inventive bearing apparatus on the whole is designated with reference number 1. In the depicted practical example, it serves for bearing of two pole terminals 2 and 3 in a housing wall (not shown in FIG. 1) of a loudspeaker or amplifier. Via pole terminal 2, an electrical connection with a cable line can be established, for example, via a banana plug or a multiple-spring wire plug insertible into a plug aperture 2′. Pole terminal 3 serves for connecting a stripped wire end by clamping. To this effect, the wire end is introduced into a slot 3′ and tightly clamped there by means of a clamping screw 3″.

The bearing apparatus 1 is comprised of a pole terminal receptacle in form of a rigid plate 4 made of plastic (e.g. polyamide with a glass fibre filling) which in the depicted practical example is provided with two recesses for the two pole terminals 2, 3. At the rim side, the rigid plate 4 is surrounded by a frame 5 made of structure-borne noise-damping material, that means made of an elastomer material (e.g. polyphenylene sulphide having a shore hardness ranging between 40 and 80). Via the frame 5, the plate 4 is supported at the housing wall. The elastic frame 5 provides for reducing structure-borne noise transmission from the housing to the pole terminals 2, 3, and besides the mounting of the pole terminals 2, 3 is executed in a conventional manner at the rigid plate 4. Pole terminals 2, 3 are plugged from above through the relevant recesses in plate 4 and bolted from the underside by means of nuts (not shown here).

FIG. 2 shows two bearing apparatuses 1, which are immobilized via their relevant elastomer frames 5 at a mounting plate 6. Mounting plate 6 is provided with appropriate recesses for the bearing apparatuses and is mounted into the housing of the loudspeaker or amplifier, thus forming a housing wall in the sense of the present invention. FIG. 2 shows the bearing apparatuses 1 without the pole terminals. The recesses for the pole terminals are designated with reference number 7 in FIG. 2. At their rims, the recesses 7 are provided with grooves which indent into the relevant noses of the pole terminals, so that the pole terminals can be fastened in a torsion-proof manner.

In FIG. 3 it can be seen that the bearing apparatuses 1 are configured as bipartite parts each. The bearing apparatuses are comprised of an upper plate part 4′ and a lower plate part 4″ each, with an upper frame part 5′ being arranged at the upper plate part 4′ and a lower frame part 5″ being arranged at the lower plate part 4″.

In the mounted state depicted in FIG. 3, the matching upper and lower frame parts 5′, 5″ form a circumferential groove between them via which the bearing apparatuses 1 are immobilized in a form-locking manner at the housing wall 6. The upper parts 4′, 5′ are inserted from the front side and the lower parts 4″, 5″ from the rear side of the housing wall 6 into the recess specifically provided for this purpose in the housing wall 6. At the upper and lower plate parts 4′ and 4″, guiding pins 8 are provided for, via which the plate parts are guided next to each other. Then the plate parts 4′, 4″are immobilized next to each other, with snap projections and/or snap recesses 9 serving this purpose. Finally immobilized next to each other are the plate parts 4′, 4″ after the pole terminals (not shown in FIG. 3) have been inserted and bolted down. The frame parts 5′, 5″ each protrude beyond the rim of the recess in mounting plate 6 from the front side and rear side, and accommodate it between them in a form-locking manner.

In the practical example shown in FIG. 3, a sponge rubber layer 10 is additionally applied on mounting plate 6. It is of no significance for the function of the inventive bearing apparatus 1.

1. Bearing apparatus for a pole terminal (2, 3) in a housing wall (6) of an electrical or electronic device, with the bearing apparatus (1) being comprised of a pole terminal receptacle for accommodating a pole terminal (2, 3), wherein the bearing apparatus (1) is provided with a structure-borne noise-damping material, wherein the pole terminal receptacle can be supported on the housing wall (6) by means of a structure-borne noise-damping material in the mounted state.

2. Bearing apparatus according to claim 1, wherein the pole terminal receptacle is comprised of a mainly rigid plate (4) with a recess (7) for accommodating the pole terminal (2, 3), and wherein the structure-borne noise-damping material forms a frame (5) at least partly surrounding the rigid plate (4) at the rim side via which the pole terminal receptacle can be supported on the housing well (6).

3. Bearing apparatus according to claim 2, wherein the frame (5) is provided with a circumferential groove via which the bearing apparatus (1) can be immobilized in a form-locking manner on the housing wall (6).

4. Bearing apparatus according to claim 2, wherein the structure-borne noise-damping material is an elastomer material.

5. Bearing apparatus according to claim 4, wherein the frame (5) made of elastomer material is injection moulded to the rigid plate (4) of the pole terminal receptacle.

6. Bearing apparatus according to claim 1, wherein the bearing apparatus (1) is of a multiple-part configuration, wherein it protrudes beyond the rim of a recess in the housing wall (6) at the front and rear side of the housing wall (6) in mounted state.

7. Bearing apparatus according to claim 1, wherein the electrical or electronic device is a device of consumer electronics.

8. Bearing apparatus according to claim 7, wherein the electrical or electronic device is a loudspeaker.
